(19) United States
(12) Patent Application Publication
(10) Pub. No.: US 2004/0216557 A1
(43) Pub. Date: Nov. 4, 2004

(54) Power split transmission with at least two input shafts

(76) Inventor: Uwe Griesmeier, Markdorf (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/834,512

(22) Filed: Apr. 29, 2004

(30) Foreign Application Priority Data
May 2, 2003 (DE) 103 19 683.8

(51) Int. Cl. F16H 37/06

(52) U.S. Cl. 74/664

(57) ABSTRACT

A power split transmission (5) having at least two input shafts (12, 14) and at least one output shaft (16) for transmitting a drive torque from one transmission unit (3) to one drive wheel (4) of a drive axle (6, 7) of a vehicle. One of the input shafts (12) is operatively connected with one output shaft (8A, 8B) and one other input shaft (14) with a transmission unit (15) and the output shaft (16) is in operative connection with the drive wheel (4).

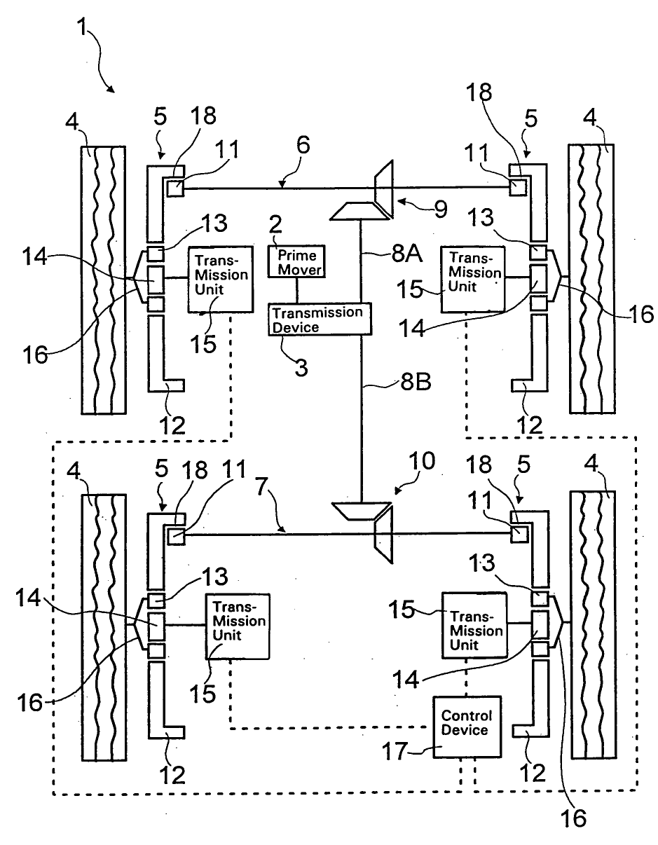

The invention concerns a power split transmission having at least two input shafts of the kind defined in detail in the preamble of claim 1.

From the practice are known different drafts of vehicle drive mechanisms which are designed with one or more simultaneously driven drive axles. A drive torque of a prime mover such as an otto motor or a Diesel internal combustion engine is transmitted via a gear to the drive axle or the drive axles. The transmission or transmission device is designed either as a continuously variable or as a stepped transmission and covers a determined range of ratios in order to make different functions possible, for example, starting off a vehicle or driving at high speeds.

Those transmission devices are usually rear-mounted so-called differential transmissions by means of which a drive torque is distributed as needed to two drive wheels of a drive axle, the same as to several drive axles of a so-called four-wheel vehicle. A differentiation is made here between so-called transverse differentials or differential transmission and so-called longitudinal differentials. Longitudinal differentials, seen in travel direction of a vehicle, are used for longitudinal distribution of the drive power of the prime mover to several driven axles of a vehicle. On the contrary, the transverse differentials, in relation to the travel direction of a vehicle, are used for transverse distribution of the drive power to drive wheels of vehicle axles.

So-called bevel gear differentials, spur gear differentials in planetary design or also worm gear differentials represent designs of differential transmission that have been known for a long time in the practice, spur gear differentials particularly being used mostly as longitudinal differentials because of the possibility of an asymmetric torque distribution. Bevel gear differentials constitute meanwhile a standard for transverse compensation in vehicles and worm gear differentials are used in vehicles both for longitudinal distribution and for transverse distribution.

By means of those distributor transmissions it is possible to distribute a drive torque in arbitrary ratios to several drive axles whereby stresses are prevented in the power train. It is further obtained by using differential transmission that drive wheels of a drive axle can be driven at different rotational speeds independently or each other according to different path lengths of the left or right lane whereby the drive torque can be distributed without yaw torque to both drive wheels.

However, against these advantages stands opposed the disadvantage that the propulsion forces transmissible to the road of two drive wheels of a vehicle axle or of two or more drive axles, due to the compensating action of a differential transmission, depend on the slight or slightest transmissible drive torque of both drive wheels or of the drive axles. This means, when a drive wheel standing, for example, on smooth ice spins that no higher torque is fed to the other drive wheel than to the spinning wheel even if it stands on soil of good feel. In such a driving situation, the vehicle disadvantageously does not start as result of the compensating action of a differential transmission which makes a rotational speed difference possible between two output shafts of a differential transmission.

Therefore, a change has been made in the practice by suitable steps to prevent a compensating movement of a differential transmission in the presence of critical driving conditions. This is implemented, for example, by a differential lock which is manually or automatically activatable by mechanical, magnetic, pneumatic or hydraulic means and by blocking the differential transmission locks up to 100% every compensating movement.

There are further used automatically locking differential which are also called differential transmission with limited slip or locking differentials. Those differential transmission make it possible to transmit a torque to a wheel of a vehicle axle or a drive axle even when the other wheel or other drive axle, in case of several drive axles, spins as a consequence of poor bottom adhesion. But at the same time, the advantage of the above mentioned yaw-torque free force transmission is lost and the free adaptation of the wheel rotational speeds of the two drive wheels of a drive axle to the path lengths of both lanes is also disadvantageously prevented.

It is further known from the practice to provide externally controlled differential brakes for adjusting a degree of compensation action of a differential transmission. Those differential brakes are mostly electronically regulated and hydraulically actuated systems in which, depending on the existing driving situation, a normally unlocked or only loosely locked differential can be locked within wide limits. An extent of the prevention of the compensating action of a differential transmission is adaptable via a control to the driving situation actually existing. For distributing the drive torque in a four-wheel vehicle at least two transverse differentials, one longitudinal differential and, in addition, three of the specified locks are required, the interplay of which disadvantageously requires for optimal driving operation high control and regulation expenses.

An alternatively to this, it is known from the practice that with each individual drive wheel of a vehicle is associated one separate electric single-wheel drive in a manner such that each drive wheel is driven according to a determined driving situation or input of an electric motor.

However, the last mentioned draft has the disadvantage that the electric motors of the single-wheel drive must have large dimensions to be able to make a vehicle with acceptable inputs available to a driver. In order to reduce the required input of the electric motors and therewith the dimensions thereof, a combination of the electric single-wheel drive with a conventional internal combustion engine represents no satisfactory solution, due to the above mentioned disadvantages in distribution as needed of the drive torque of an individual transmission unit.

In another drive draft with power distribution known from the practice, it is provided that the individual drive wheels be coupled via frictional clutches with variable transmission capacity on a power train. But those drive drafts, due to the clutches working mostly in slip operation, are associated with power losses which reduce the effectiveness.

This invention is based on the problem of making a power split transmission available with which the known disadvantages from the practice are prevented in the transmission of a drive torque to a drive wheel.

According to the invention the problem is solved with a power split transmission having the features of claim 1.

With the inventive power split transmission, which has at least two input shafts and at least one output shaft for transmitting, a drive torque from a transmission device to a drive wheel of a drive axle of a vehicle makes it advantageously possible to start a vehicle when a drive wheel of a drive axle stands on slippery soil and the other drive wheel of the vehicle axle is upon soil of good feel, since a compensation appearing in the transmission differentials known from the practice can be easily varied without compensation differential and, at the same time, an operation of the two drive wheels of a vehicle axle, having different rotational speeds, is made possible.

This is achieved by the fact that one of the two input shafts of the inventive transmission is operatively connected with one output shaft of the transmission device and one other input shaft of the inventive transmission with one transmission unit. In addition, the output shaft of the transmission is operatively connected with the drive wheel in a manner such that on each drive wheel, via the transmission unit, an as needed adjustment of a rotational speed of a drive wheel or of a wheel-side output rotational speed, corresponding to a determined driving state, is possible on each drive wheel. Therewith a yaw-torque free force transmission departing from a prime mover of a vehicle to the drive wheels of the vehicle is possible.

As result of the structurally simple design, the inventive power split transmission can be integrated in conventional drive drafts or power trains of vehicles and, without problem, can be built up in a vehicle on the point in which the transverse differentials have hitherto been positioned so that the inventive transmission can be integrated without great expense in vehicle constructions already existing.

There further underlies the inventive power split transmission, the advantage that with the coupling of one of the input shafts with the transmission unit, it is possible, as needed, to produce a wheel-side output rotational speed corresponding to the driving state on a drive wheel or on all drive wheels and the input needed for this purpose are substantially less than is the case for the known electrical single-wheel drives.

In addition a total effectiveness of a power train, designed with the inventive power split transmission, is greater compared to the power trains known from the practice in which the drive wheels are coupled on the power train and the prime mover thereof, via variable clutches, since the power losses occurring in the variable clutches do not occur in the inventive transmission.

Other advantages and advantageous developments of an inventive power split transmission result from the description, the drawing and the claims.

An embodiment of an inventive power split transmission is shown diagrammatically simplified in the drawing and is explained in detail in the description that follows.

The single FIGURE of the drawing shows greatly schematized a partial view of a power train of a four-wheel passenger car with one prime mover, one transmission device and one inventive power split transmission located between the transmission device and one drive wheel.

Referring to the FIGURE, it shows a power train 1 of a four-wheel passenger car greatly schematized, which comprises one prime mover 2, one transmission device 3 rear-mounted in the power flow of the power train 1 of the prime over and one split power transmission 5 intercalcated between a drive wheel 4 and the transmission device 3.

The transmission device 3 is designed as a multi-group transmission which, in a manner not shown in detail and known per se, is formed by one main transmission and one longitudinal distributor transmission rear-mounted on the main transmission. Via the longitudinal distributor transmission, a drive torque of the prime mover is distributed to a drive front axle 6 and to a drive rear axle 7 of the four-wheel passenger car. The drive torque of the prime mover 2 distributed via the transmission device 3 is passed via two output shafts 8A, 8B, respectively, via one bevel gear transmission 9, 10 to the two drive axles 6 and 7.

The drive rear axle 7 is here designed on its end facing the power split transmission 5 with a spur gear 11 which meshes with a ring gear 12 of the power split transmission 5 designed as a planetary gear set, the ring gear 12 constituting here a transmission input shaft of the power split transmission 5. The ring gear 12 is designed with one inner toothing 18 in which engages the spur gear 11 and with which a rotational speed inversion is prevented in this place.

The ring gear 12 driven via the drive gear axle 7 meshes, in turn, with planetary gears 13 of the transmission 5 which are engaged with a sun gear 14 of the transmission 5. The sun gear 14 is connected with a transmission unit 15 and represents here, like the ring gear 12, a transmission input shaft of the power split transmission 5 so that a drive torque, outcropping on the ring gear 12, can be supported or eventually increased via the prime mover 2.

The planetary gears 13 are rotatably supported upon a planet carrier 16 which, in turn, is connected with the drive wheel 4 and is here an output shaft of the power split transmission so that, depending on a drive torque of the prime mover 2 outcropping via the ring gear 12 and on a torque eventually produced by the transmission unit 15 and outcropping on the sun gear 14, a resulting drive torque abuts on the drive wheel 4.

The transmission unit 15 is designed as an electric motor which, by means of its variable and direction reversible rotational speed, makes an adjustment of a wheel-side rotational speed of the drive wheel 4 corresponding to a driving state possible. That is, when the transmission unit 15 is operated as a motor, a rotational speed or a drive torque of the drive wheel 4 can be increased by an accelerating torque of the transmission unit 15 and when the transmission unit 15 is operated as a generator, a drive torque of the drive wheel 4 is reduced as a result of a brake torque of the transmission unit 15.

As shown in the FIGURE, on each one of the drive wheels 4 of the four-wheel passenger car, a power split transmission 5 with one transmission unit 15 operatively connected with a sun gear 14 is front-mounted for adjusting a wheel-side rotational speed corresponding to the driving state of each of the four drive wheels 4. The transmission units 15 of the individual drive wheels 4 are all operatively connected with a control device 17 so that, according to a detected drive condition, a rotational speed that ensures a reliable driving behavior of the vehicle is adjustable on each drive wheel 4 according to the rotational speeds of the other drive wheels.

With this specified arrangement or development of the power train 1, it is now possible to operate the four drive wheels at different rotational speeds, which acts positively on the driving behavior of the vehicle, especially when cornering, in case of changing road characteristics or also in the case of strong cross wind.

In generator operation, the rotational speeds of the drive wheels inside the curve can be reduced via electric motors associated with said drive wheels and the rotational speeds of the drive wheels outside the curve can be increased via the electric motors then operating as motors and associated with said drive wheels so that when the vehicle is cornering it is positively influenced.

It is also possible, via a drive torque applied by the electric motor or the transmission unit 15, to support a drive wheel which stands upon smooth soil and would spin due to the drive torque of the prime mover 2 fed to it, so that a spinning of the drive wheel is prevented and the other drive wheel connected with the same drive axle is supplied with a sufficient drive torque whereby a starting of the vehicle is ensured.

A vehicle can be started in forward or reverse travel direction via the separate transmission units associated with the drive wheels and which can be designed as electric motors or also as hydraulic transmission units. At the same time, a motion in continuation of the start off operation is provided in forward or reverse travel direction to effect with the drive mechanism of the prime mover.

If no support torque is applied via the transmission unit 15 to the power split transmission 1 or to the sun gears 14, the transmission device 3 can be left in gear similar to a so-called “neutral geared” state of a transmission. The transmission device(s) can also be left in gear when the vehicle is stopped without “stalling” the prime mover 2, which is designed as internal combustion engine. The drive torque fed to the drive wheels 4 via the drive axles 7 and 8, is transmitted via the fixed planet carrier 16 to the sun wheels 14 in a direction of the transmission unit where it produces without counter torque only a rotation of one input shaft while none of the drive wheels rotates.

With the inventive drive draft of a power split transmission and of a transmission unit operatively connected there can also be easily produced a functionality of an electronic stabilization program (ESP) by a controlled accelerating or braking engagement of the transmission unit. If the transmission unit is designed as an electric motor, it is additionally possible to carry out an energy recovery with suitable memory device, during the braking engagement which can be implemented by an operation as generator of the electric motor.

Another possible functionality which can be implemented with the inventive drive draft consists in that, while the vehicle is stopped, one or more transmission units can assume a so-called starter function for the prime mover designed as internal combustion engine whereby, after the prime mover has been started, the above mentioned operating state “geared neutral” can be produced.

Another advantage resulting from the use of the inventive split power transmission is that the diameters of longitudinal and transverse shafts provided in the vehicle for distribution of the drive torque of the prime mover can be made with smaller dimensions since a higher rotational speed of said shafts has to be lowered first in the inventive split power transmission to a wheel rotational speed.

In an advantageous development of the object of the invention, it is provided that the electric motor is designed with one brake or that, in the input shaft operatively connected with the electric motor, a brake engages by way of which a high supporting torque can be produced without power consumption of the electric motor on the input shaft of the power split transmission operatively connected with the electric motor. Therewith is possible to make the electric motor of smaller dimensions and support power peaks via the brake. It is further possible to reduce a power consumption of the electric motor by engaging the brake and to relieve the electric motor in case of long sustained loads which can lead to eventual damage of the electric motor whereby the service life of the electric motor can be extended.

The development shown in the FIGURE of the inventive power split transmission which has at least two input shafts and at least one output shaft to transmit a drive torque from one transmission device to a drive wheel of a drive axle of a vehicle can be replaced, depending on the intended use, by any other suitable planetary gear with which can be accomplished the operating principle specified according to the invention.

It is thus absolutely possible to connect the transmission unit with the ring gear or with the planet carrier of the inventive transmission or to couple a transmission output shaft of a main transmission with the ring gear or the sun gear. It is also conceivable that the transmission be designed as a double planetary gear set with two planetary gear sets which are adequately crossed with each other, the transmission output shaft being connected with the output gear and each one of the two input shafts with the outputs shaft of a main transmission or the transmission unit.

Reference Numerals

1 power train

2 prime mover

3 transmission device

4 drive wheel

5 power split transmission

6 drive forward axle

7 drive rear axle

8A, 8B transmission output shaft

9 bevel gear transmission

10 bevel gear transmission

11 spur gear

12 ring gear

13 planetary gears

14 sun gear

15 transmission unit

16 planet carrier

17 control device

18 toothing of the ring gear

1-10. (canceled).

11. A power split transmission (5) comprising at least two input shafts (12, 14) and at least one output shaft (16) for transmitting a drive torque from a transmission device (3) to a drive wheel (4) of a drive axle (6, 7) of a vehicle, wherein a first of the input shafts (12) is operatively connected with one output shaft (8A, 8B) and a second of the input shafts (14) with a transmission unit (15) and the output shaft (16) is in operative connection with the drive wheel (4).

12. The power split transmission according to claim 11, wherein a drive rotational speed of the transmission unit (15) is variable and irreversible in a direction of rotation.

13. The power split transmission according to claim 11, wherein the transmission unit (15) is designed as an electric motor.

14. The power split transmission according to claim 13, wherein the electric motor has one of a brake or the input shaft operatively connected with the electric motor can be coupled with a brake by which a high support torque can be produced without power consumption of the electric motor on the input shaft operatively connected with the electric motor.

15. The power split transmission according to claim 11, wherein said transmission unit (15) is designed as a hydraulic motor.

16. The power split transmission according to claim 11, wherein a bevel gear toothing (9, 10) is provided between the output shaft (8A, 8B) of the transmission device (3) and the input shaft (12).

17. The power split transmission according to claim 11, wherein the transmission (5) is designed as a planetary gear set.

18. The power split transmission according to claim 17, wherein the first input shaft (12) operatively connected with the output shaft (8A, 8B) of the planetary gear set is a ring gear.

19. The power split transmission according to claim 17, wherein the second input shaft (14) of the planetary gear set operatively connected with the transmission unit (15) is a sun gear of the planetary gear set.

20. The power split transmission according to claim 17, wherein the output shaft (16) of the planetary gear set operatively connected with the drive wheel (4) is a planet carrier of the planetary gear set.
